(19) United States
(12) Patent Application Publication
(10) Pub. No.: US 2016/0042398 A1
(43) Pub. Date: Feb. 11, 2016

(54) INDOOR INFORMATION PUSH SYSTEM AND METHOD USING LED LIGHTING DEVICES

(71) Applicant: ZHEJIANG SHENGHUI LIGHTING CO., LTD, Jiaxing, Zhejiang (CN)

(72) Inventors: JIABIN TUO, Jiaxing (CN); CHAOQUN SUN, Jiaxing (CN); JINXIANG SHEN, Jiaxing (CN)

(21) Appl. No.: 14/421,284

(22) PCT Filed: Nov. 11, 2014
(86) PCT No.: PCT/CN2014/090814

§ 371 Date: Feb. 12, 2015

(30) Foreign Application Priority Data
Nov. 12, 2013 (CN) 201310559800.2

(51) Int. Cl. G06Q 30/02; H05B 37/02

(52) U.S. Cl. CPC G06Q 30/0267; H05B 37/0272

(57) ABSTRACT

The present disclosure provides an information push system and method using LED lighting devices. The information push system includes an LED lighting device with a built-in Wi-Fi module; an information storage server configured to wirelessly communicate with the LED lighting device, and store and transmit advertisement and product information; and a user terminal configured to wirelessly communicate with the LED lighting device, send related service requests, or receive data. The information storage server and the LED lighting device form an indoor wireless network. When a user terminal connects to the indoor wireless network, the information storage server transmits the advertisement and product information to the user terminal via the indoor wireless network.

### CROSS-REFERENCES TO RELATED APPLICATIONS

This application claims the priority of Chinese Patent Application No. 201310559800.2, entitled “Indoor Information Push System and Method Using LED Lighting Devices,” filed on Nov. 12, 2013, the entire content of which is incorporated herein by reference.

### FIELD OF THE DISCLOSURE

The present disclosure relates to the field of of light emitting diode (LED) and indoor information push technologies, more particularly, relates to a information push system and method using LED lighting devices.

### BACKGROUND

LED technologies provide many advantages including high-energy efficiency, eco-friendliness, controllable lighting, durable quality, long lifespan, etc. To promote low carbon living and protect environment, LED technologies have been widely adopted in various lighting applications.

Along with the development and widespread of information technology, people receive more and more contents from various information resources. Currently, there are several common indoor (for example, exhibition centers, department stores, supermarkets, etc.) information push systems and methods. The first option is to save information of all exhibits/products to a guiding device (such as iPod, iPad, tablets and other specially designed devices). When a user wants to find out about a certain item, he/she needs to manually search for it by locating the exhibit/product section on a specific software and listen to the introduction through speakers or headphones. Comparing to distributing paper-based promotional materials, this method is environmentally friendly because it uses reusable devices, and the exhibits/merchandise database could be regularly updated. However, there are some drawbacks with this method. For example, it may be inconvenient and time-consuming for the users to manually locate a specific item. It may be expensive to purchase and maintain these guiding devices and headphones. The guiding devices may need to be manually and individually updated, which may be a significant task. The exhibits/merchandise information database may take up large storage spaces in the guiding devices, which may require costly hardware upgrades.

The second option is to use guiding devices that store all exhibits/merchandise information together with a specially designed information push module for each exhibit/product. When a user is in the vicinity of a certain exhibit/product (within a specific range), its information push module will send a corresponding play command to the guiding device wirelessly via a Wi-Fi, blue tooth, infrared or RFID transmission. In this case, the users do not need to manually search for a specific item. Nonetheless, there are still some shortcomings. It may be expensive to purchase and maintain the guiding devices and headphones. It may also be expensive to provide every exhibit/product with a corresponding information push module. It may require the guiding device to be within certain distance of the exhibits/products to avoid interferences and false commands, which may lead to waste of floor space. The exhibits/merchandise information database may take up large storage spaces in the guiding devices, which may require costly hardware upgrades.

The disclosed method and system are directed to solve one or more problems set forth above and other problems.

### BRIEF SUMMARY OF THE DISCLOSURE

The present disclosure overcomes the shortcomings of the prior art described above, and provides a user friendly and easy to upgrade information push system and method using LED lighting devices.

One aspect of the present disclosure provides an information push system using one or more LED lighting devices. The information push system includes an LED lighting device with a built-in Wi-Fi module; an information storage server configured to wirelessly communicate with the LED lighting device, and store and transmit advertisement and product information; and a user terminal configured to wirelessly communicate with the LED lighting device, send related service requests, or receive data. The information storage server and the LED lighting device form an indoor wireless network. When a user terminal connects to the indoor wireless network, the information storage server transmits the advertisement and product information to the user terminal via the indoor wireless network.

Another aspect of the present disclosure provides a method for information push using one or more LED lighting devices. The information push method includes installing at least one LED lighting device with a built-in Wi-Fi module in an indoor space, and forming, by the LED lighting device and an information storage server, an indoor wireless network. The method further includes connecting to a network node of the indoor wireless network with Wi-Fi signals, when a user terminal moves within an effective range in the indoor space; receiving a service request at the information storage server through the LED lighting devices in the wireless network; and transmitting requested information, including information about a sale, an exhibit, or a product, to the user terminal through the wireless network using the LED lighting devices.

Embodiments of the present disclosure do not require designated guiding devices, and implement the indoor information push system using LED lighting devices with built-in Wi-Fi modules. As a result, embodiments of the present disclosure have low maintenance costs, fast information update speeds, and are convenient to use.

### BRIEF DESCRIPTION OF THE DRAWINGS

The following drawings are merely examples for illustrative purposes according to various disclosed embodiments and are not intended to limit the scope of the present disclosure.

FIG. 1 is a schematic block diagram of an exemplary indoor information push system using LED lighting devices consistent with the present disclosure;

FIG. 2 is another schematic block diagram of an exemplary indoor information push system using LED lighting devices consistent with the present disclosure; and

FIG. 3 is a flow chart diagram of an exemplary indoor information push method using LED lighting devices consistent with the present disclosure.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

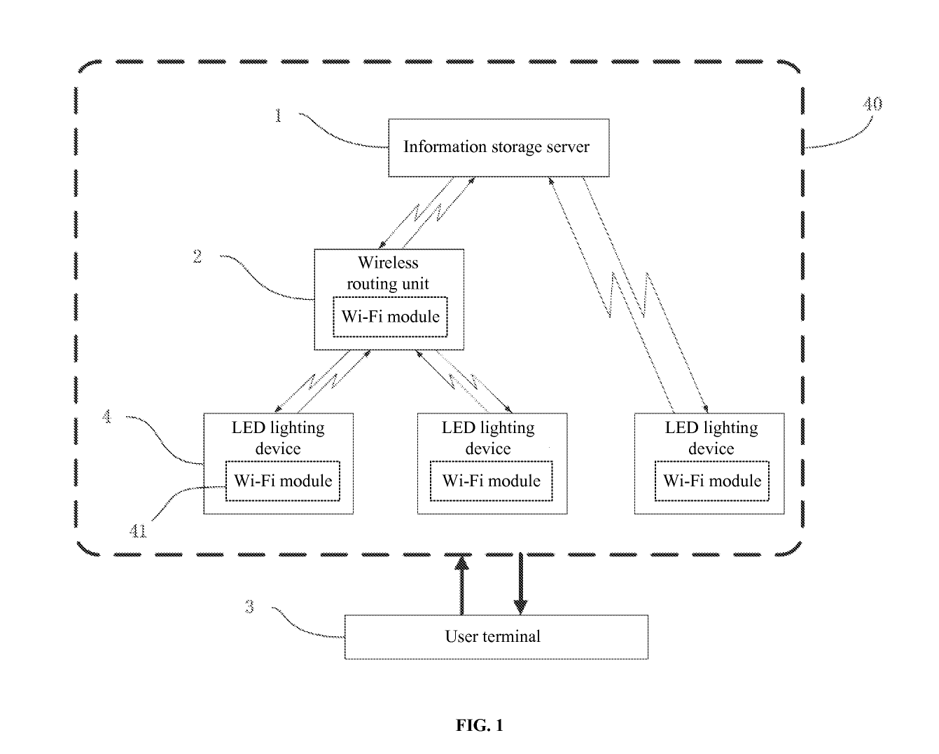

FIG. 1 is a block diagram of an exemplary indoor information push system using LED lighting devices consistent with the present disclosure. As shown in FIG. 1, an indoor information push system using LED lighting devices includes an information storage server 1, a wireless routing unit 2, a user terminal 3, and at least one LED lighting device 4. In the present embodiment, if the LED lighting device 4 has routing capacities, the wireless routing unit 2 is not necessary. The LED lighting device 4 may be any device incorporating an LED lighting component (e.g., an LED light) and a wireless communication component (e.g., a Wi-Fi module).

For example, an LED lighting device 4 further includes a driving power supply, an LED light-emitting component, and a RF (radio frequency) antenna. The Wi-Fi module 41 of each LED lighting device 4 is configured to receive data from a wireless router or a wireless gateway via the RF antenna, to process the data, and to send the processed data to the smart terminal via the RF antenna. The Wi-Fi module 41 of each LED lighting device 4 is configured to control the driving power supply to control a switching status, brightness, and color temperature of the LED lighting device according to a control command signal sent from the smart terminal. The Wi-Fi module 41 of each LED lighting device 4 and the driving power supply are integrated together on a same circuit board or are connected together via a connector. The Wi-Fi module 41 of each LED lighting device is attached on an outer surface of a housing of the LED lighting device 4 or configured independently from the LED lighting device 4.

The introductory information of exhibits/products in exhibition centers, shopping malls, and supermarkets, the floor plan of indoor exhibition/shopping areas and the location of various service facilities, emergency safety exit distributions and marketing information about hot exhibits or sale products may all be saved in the information storage server 1. When a user terminal connects to the indoor wireless network and requests service information, the information storage server 1 may deliver relevant contents through multiple levels of the LED lighting devices 4 to the user terminal 3 with high speed Wi-Fi data transmission capacity. For example, the data from the the information storage server 1 may “ripple” through the network nodes of LED lighting devices 4 to reach the user terminal 3. The information storage server 1 may also transfer the data to the user terminal 3 by determining and then taking the shortest distance from the information storage server 1 to the user terminal 3 on the network.

Further, the information storage server 1 neither has the capacity to store the location information of each Wi-Fi module, nor to retrieve the location information corresponding to the MAC address of each Wi-Fi module saved in an external location server. Therefore, the system does not support indoor positioning or navigation functions.

Moreover, the information storage server 1 does not analyze the user's current location and push exhibits/products information corresponding to the location. Instead, the information storage server 1 only pushes product promotion advertisements, exhibit information, and activity information uniformly to the user terminals connected with the indoor wireless network. When a user terminal 3 needs to find out about the introductory information of a certain exhibit/product, the information storage server 1 performs an analysis of the user's request and transmits corresponding data information to the user. The time for information push may be when a user terminal just connects to the indoor wireless network, or when a user terminal requests certain services. The information push may also be sent at scheduled times to registered user terminals on the internet.

The wireless routing unit 2 may connect and communicate with the information storage server 1 through cable or wireless connections. The LED lighting device 4 may connect to the wireless routing unit 2 by the built-in Wi-Fi module 41. If in the effective wireless broadcast range of the information storage server 1, the built-in Wi-Fi module 41 of the LED lighting device 4 may communicate directly with the information storage server 1 wirelessly instead of connecting through the wireless router unit 2.

The information storage server 1, the wireless routing unit 2 and a plurality of LED lighting devices 4 may form an indoor wireless network 40. The wireless network 40 broadcasts with a unique SSID. That is, all indoor wireless devices may be directly connected to transmit data. A user terminal 3 may access the wireless network 40. When moving indoors within an effective range, the user terminal 3 can transmit related data or control commands through multiple levels or layers of LED lighting devices 4.

Furthermore, in the indoor information push system consistent with the present disclosure, if the built-in Wi-Fi module 41 of the LED lighting device 4 has wireless routing capacities, the wireless communication between the LED lighting device 4 and the wireless router unit 2 is not necessary. That is, each LED lighting device 4 acts as a wireless access point, delivers the Wi-Fi signals from the information storage server to next level, i.e., the next level of LED lighting devices 4, so that the coverage range of Wi-Fi signals can be expanded by the LED lighting devices 4 and all the nodes (LED lighting devices 4) can be connected to the intranet or internet.

If a user terminal 3 enters an exhibition center/shopping mall for the first time, when connecting to the indoor wireless network 40 with a uniformed broadcast Wi-Fi SSID, the user needs to first follow the prompts to download and install an application provided by the exhibition center/shopping mall. When the user terminal 3 opens the application, the information storage server 1 may actively send promotions or background information of exhibits/products to the user terminal 3 through levels of the indoor wireless network nodes. The user terminal application may provide a menu of exhibits/products. If the user wants to know the background information about a specific exhibit/product, the user may manually select the item in the user terminal application. Then the information storage server may send related information to the user terminal through high-speed Wi-Fi connections and levels of network nodes. When moving freely indoors within an effective range, the user terminal can automatically connect to a nearby network node with the strongest Wi-Fi signal, while the node connecting and switching program runs in the application software background.

The user terminal application doesn't have to be downloaded when the user terminal is connected to the indoor wireless network. As long as the user terminal has access to the internet, the application can be downloaded in advance without charge at common application stores (e.g. Google Play, 360 App Center, etc.).

The information storage server 1 processes data or service requests from the user terminal 3, and transmits to the user terminal 3 requested information of related exhibits/products, floor plans of indoor exhibition/shopping areas, traffic information of each indoor exhibition/shopping areas, service status of nearby facilities (such as ticketing office, cashier, customer service, restroom, gift shop and indoor or outdoor parking lot), exhibits or promotional products, price comparison information from the internet by product name or product bar code.

In embodiments consistent with the present disclosure, the user terminal 3 may be a desktop computer, a laptop computer, a tablet computer, a smart phone, a smart music player, etc.

When a user terminal 3 enters and connects to the indoor wireless network 40 with an unique SSID, the information storage server 1 sends background information of sale or exhibits/products through the wireless routing unit 2 or the LED lighting devices 4 in the wireless network 40 through layers of network nodes (LED lighting devices 4) to the user terminal 3. The number of LED lighting devices 4 involved in the data transmission may be more than one. In addition, if the user terminal 3 has administrative access, it may control the working status of any of the LED lighting devices 4 in the wireless network 40, such as switching the lights on/off, adjusting the brightness, setting automatic on/off time, and recording electricity consumption.

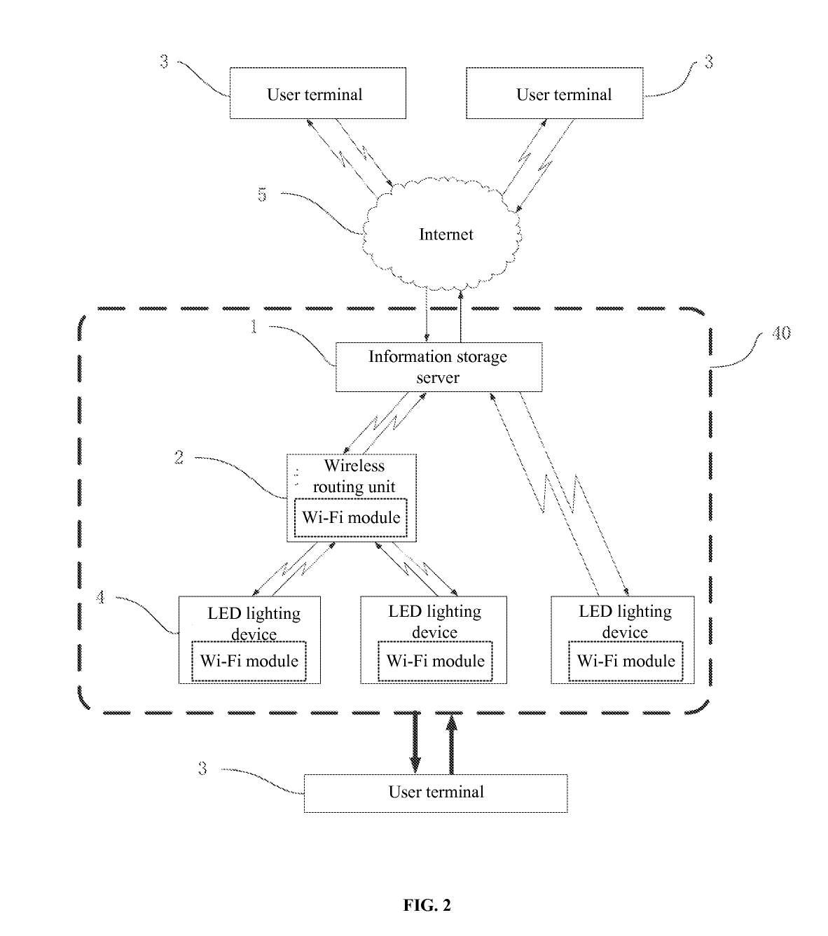

FIG. 2 is another block diagram of an exemplary indoor information push system using LED lighting devices consistent with the present disclosure. As shown in FIG. 2, the information storage server 1 may connect to the internet 5 and indirectly transmits data or control commands to all user terminals 3.

Moreover, if the information storage server 1 is connected to the internet, the user terminal 3 may also access the internet by connecting to the indoor wireless network 40. While shopping and browsing, the users may surf the internet at high speed through evenly distributed LED lighting devices 4 with built-in Wi-Fi modules. The user terminal 3 may also provide price comparison functions, comparing prices with other stores and online shopping websites by accessing the internet.

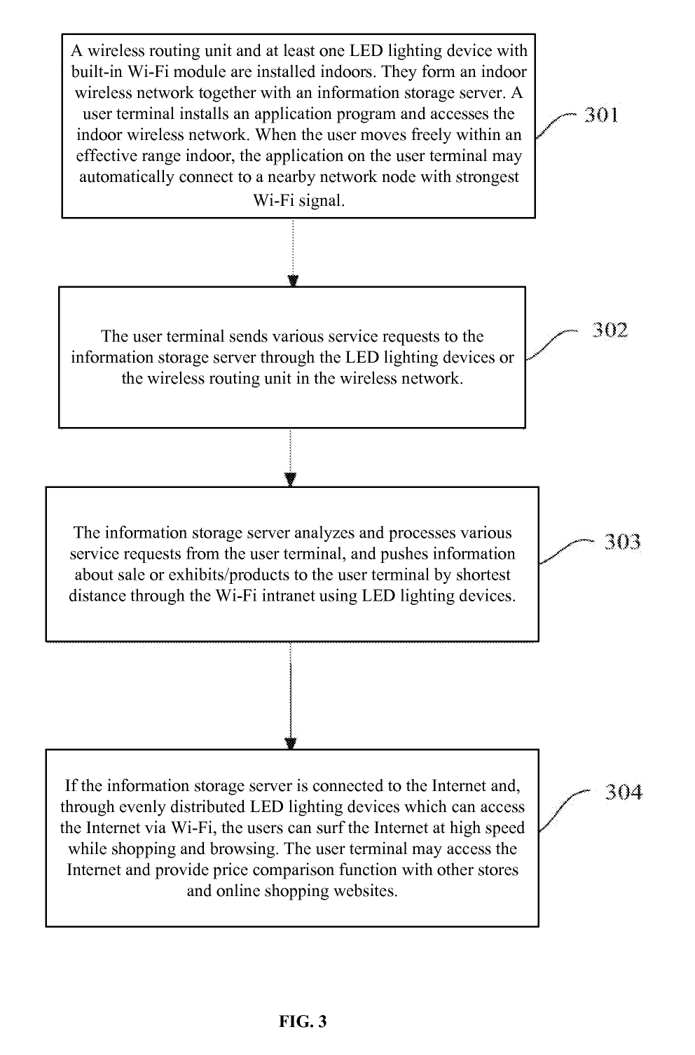

FIG. 3 is a flow chart of an exemplary indoor information push method using LED lighting devices consistent with the present disclosure. The method includes the following steps.

Step 301: A wireless routing unit 2 and at least one LED lighting device 4 with a built-in Wi-Fi module are installed in an indoor space. They form an indoor wireless network 40 together with an information storage server 1. A user terminal 3 installs an application program and access the indoor wireless network 40. When the user moves freely within an effective range indoor, the application on the user terminal 3 may automatically connect to a nearby network node with the strongest Wi-Fi signal.

Step 302: The user terminal 3 sends various service requests to the information storage server 1 through levels of the LED lighting devices 4 or the wireless routing unit 2 in the wireless network 40.

Step 303: The information storage server 1 analyzes and processes various service requests from the user terminal 3 and pushes information about sale or exhibits/products to the user terminal 3 by shortest distance through the Wi-Fi intranet using LED lighting devices 4.

Step 304: If the information storage server 1 is connected to the internet and, through evenly distributed LED lighting devices which can access the internet via Wi-Fi, the users can surf the internet at high speeds while shopping or browsing. The user terminal 3 may access the internet and provide price comparison functions, comparing prices with other stores and online shopping websites.

In summary, the present disclosure does not require designated guiding devices (i.e., receiving devices of push data). As smart phones and tablets become more and more popular, a user can simply install on his or her personal mobile phone or a tablet computer an application developed by an exhibition center, shopping mall, or supermarket. The application is convenient and easy to understand. The exhibition centers, shopping malls or supermarkets save the expense for purchasing, maintaining, and upgrading guiding devices. As a result, embodiments consistent with the present disclosure improve business efficiencies and productivities. The exhibition centers, shopping malls, or supermarkets may provide a two-dimensional code of the application installation package for users to download and install. They may also put the application in a common application store (such as: Google Play, 360 App Center, etc.) for free downloads.

In addition, the application does not limit users to stay at a specific indoor location to obtain relevant service information or send/receive control commands. Even though at other indoor locations or any outdoor locations, as long as the user can connect to the internet and have certain access permissions, the user can send or receive relevant information or control commands to the information storage server 1.

Further, the sale or exhibits/products information and the exhibits/products database doesn't have to be stored in the user terminal 3 in advance. The related data may be directly transferred and downloaded from the information storage server 1 according to users' requirements through a high-speed Wi-Fi LAN. The LED lighting devices 4 are simply an information channel for high-speed data transmission from the server or external network to the user terminals.

Moreover, the information storage server 1 may collect and update the working status of indoor public facilities. In shopping malls or supermarkets, information includes guidance to specific product/product section, shopping route suggestions and planning, promotion section route guidance and sale item introduction, traffic information inquiry of each product sections, nearby service facilities and status inquiry (such as cashier, bag check, gift shop, restroom), fire escape route guidance, etc. In exhibition centers, such information includes guidance to specific exhibit/exhibition area, tour route suggestions and planning, traffic information of each exhibition area, nearby service facilities and status inquiry (such as: ticketing office, bag check, restroom, gift shop, etc.), fire escape route guidance, etc.

The disclosed embodiments are merely examples for illustrative purposes. The embodiments does not describe all the details and shall not limit the present invention to the particular embodiments. It is apparent that, according to the contents of this specification, various modifications and changes can be made. The selected and detailed described embodiments in this specification are used to explain the principles and practical applications of the present invention, so that the ordinary skill in the art can make good use of the present invention. The present invention is limited only by the full scope of the claims and equivalents thereof It is intended that the specification and examples be considered as exemplary only. Based on the disclosed embodiment, persons of ordinary skill in the art may derive other embodiments consistent with the present disclosure, all of which are within the scope of the present invention.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

The information push system and method using LED lighting devices consistent with the present disclosure does not require designated receiving devices. As smart phones and tablets become more and more popular, a user only need to install an application developed by a certain exhibition center, department store, or supermarket on a smart device. The information push functions are convenient and easy to understand. The exhibition center, department store, or supermarket saves expenses by not needing to purchasing, maintaining and updating specific guiding devices. In addition, the application does not limit users to stay at a specific indoor location to obtain relevant service information or send/receive control commands. As long as he/she can connect to the internet or the intranet, and have certain access permissions, the user can send or receive relevant information or control commands to the information storage server.

Further, the present disclosure provides indoor data pushing capabilities that may allow a user to locate a specific item or product category quickly and accurately. Embodiments consistent with the present disclosure may also be implemented in outdoor spaces, such as a public square or a sports arena. Embodiments consistent with the present disclosure may form a local network of LED lighting devices with Wi-Fi modules and an information storage server. A user terminal may connect to the local network. Embodiments consistent with the present disclosure may locate user terminals through the in-network LED lighting devices with Wi-Fi modules that are placed throughout the outdoor space. The information storage server may push data relevant to the user terminals through the LED lighting devices.

Moreover, the information storage server may collect and update the working status of other indoor/outdoor facilities. In department stores or supermarkets, such information includes guidance to specific product/product sections, shopping route suggestions and planning, promotion section route guidance and sale item introduction, traffic updates of each product sections, nearby service facilities and status inquiries (such as status of the cashier counter, bag check, gift shop, restroom), fire escape route guidance, etc. In exhibition centers, such information includes guidance to specific exhibit/exhibition area, tour route suggestions and planning, traffic information of each exhibition area, nearby service facilities and status inquiries (such as a ticketing office, bag check, restroom, gift shop), fire escape route guidance, etc.

What is claimed is:

1. An information push system using LED lighting devices, comprising:
an LED lighting device with a built-in Wi-Fi module;
an information storage server configured to wirelessly communicate with the LED lighting device, and store and transmit advertisement and product information; and
a user terminal configured to wirelessly communicate with the LED lighting device, send related service requests, or receive data;
wherein the information storage server and the LED lighting device form an indoor wireless network; and when a user terminal connects to the indoor wireless network, the information storage server transmits the advertisement and product information to the user terminal via the indoor wireless network.

2. The information push system using LED lighting devices according to claim 1, further comprising:
a wireless routing unit including a built-in Wi-Fi module;
wherein the wireless routing unit, the information storage server, and the LED lighting device form the indoor wireless network.

3. The information push system using LED lighting devices according to claim 1, wherein the information storage server accesses the internet and performs data transmission or control with user terminals.

4. The information push system using LED lighting devices according to claim 1, wherein the information storage server connects to the internet, allows the user terminal to surf the internet through evenly distributed LED lighting devices which access the internet via Wi-Fi; and the user terminal accesses the internet and provides a price comparison, comparing a price of a product in a store or an online shopping website.

5. The information push system using LED lighting device according to claim 1, wherein the user terminal is a smart phone, a desktop computer, a laptop computer, a tablet, and a smart music player.

6. An information push method using LED lighting device, comprising:
installing at least one LED lighting device with a built-in Wi-Fi module in an indoor space;
forming, by the LED lighting device and an information storage server, an indoor wireless network;
connecting a user terminal to a network node of the indoor wireless network with Wi-Fi signals, when the user terminal moves within an effective range in the indoor space;
receiving a service request from the user terminal at the information storage server through the LED lighting devices in the wireless network; and
transmitting requested information, including information about a sale, an exhibit, or a product, to the user terminal through the wireless network using the LED lighting devices.

7. The information push method using LED lighting devices according to claim 6, further comprising:
connecting the information storage server to the internet;
enabling the user terminal to surf the internet while shopping and browsing in the indoor space through evenly distributed LED lighting devices; and
providing a price comparison of a product, comparing a price with a store or an online shopping website via the internet.

8. The information push method using LED lighting device according to claim 6, wherein the user terminal controls working status of the LED lighting device, such as switching a light on/off, adjusting brightness, setting automatic on/off time, and recording power consumption.

9. The information push method using LED lighting devices according to claim 6, further comprising:
installing a wireless routing unit with a built-in Wi-Fi module in the indoor space; wherein the wireless routing unit communicates with the information storage server through a cable or Wi-Fi connection; and the LED lighting device communicates with the wireless routing unit through a Wi-Fi connection.

10. The information push method using LED lighting devices according to claim 9, wherein the requested information reflects status of a service provided in the indoor space.
